(19) United States
(12) Patent Application Publication
(10) Pub. No.: US 2020/0229436 A1
(43) Pub. Date: Jul. 23, 2020

(54) DESICCANT AND BIOCIDE FORMULATION FOR THE AGRICULTURAL INDUSTRY WITH LOW ENVIRONMENTAL IMPACT

(71) Applicant: Domenico TERENZIO, Terracina (IT)

(72) Inventor: Domenico TERENZIO, Terracina (IT)

(21) Appl. No.: 16/645,471

(22) PCT Filed: Aug. 30, 2018
(86) PCT No.: PCT/IB2018/056636

§ 371 Date: Mar. 8, 2020

(30) Foreign Application Priority Data
Sep. 7, 2017 (IT) 102017000100437

(51) Int. Cl. A01N 37/02; A01N 25/22; A01N 25/14; A01N 65/20; A01N 43/16

(52) U.S. Cl. CPC A01N 37/02; A01N 25/22; A01N 43/16; A01N 65/20; A01N 25/14

(57) ABSTRACT

The present invention relates to formulations with a desiccant and biocidal activity.

The present invention relates to the agronomic field, and in particular provides formulations with a desiccant and biocidal activity.

The use of highly residual synthetic products, in the agricultural industry (and not) has created, over the years, a great deal of damage to the ecosystem causing pollution of soils, groundwater and thus damaging the entire food chain.

The irrational use of chemical formulations, particularly of substances with an herbicidal action (such as for example glyphosate, atrazine, Paraquat and Diquat, methyl bromide used in soil fumigation, etc.) has created, in the last decades, a strong environmental impact.

Glyphosate (better known by the trade name of Roundup) is the most widely used herbicide in the world and was introduced as an ecological and biodegradable herbicide.

In fact, after many years it has shown a disastrous and irreversible environmental impact.

Several international studies have shown that glyphosate can accumulate and persist in soil for years, destroying the beneficial microorganisms of the soil and polluting the groundwater below.

Being a preparation provided with a basipetal system (that is, absorbed by the leaves and translocated to the roots), it is translocated from the epigeal to the hypogeal apparatus, thus protecting itself from being washed away.

Therefore, through the consumption of treated agricultural products, glyphosate reaches the intestine and alters the intestinal microbial flora thereof; as a result, our immune system is damaged, thereby lowering its defenses against diseases.

Furthermore, as glyphosate is a strong chelating agent, repeated use immobilizes the micronutrients (up to 80-90% of iron, zinc and manganese) making them unavailable to plants.

The need to have eco-friendly formulations with low environmental impact, environment-friendly and not harmful to human health, for the elimination of weeds and fungi and bacteria from crops is therefore felt.

### Object of the Invention

The invention first relates to formulations having a desiccant action.

In an alternative aspect, the formulations of the invention have biocidal activity.

In a further aspect, the formulations of the invention have desiccant and biocidal activity.

The process for their preparation is a further subject.

According to the invention, a third aspect consists of a desiccant (optionally also desuckering) method for weeding comprising the use of the formulations of the invention.

In an alternative aspect, a biocidal method comprising the use of the formulations of the invention is also described.

In a further aspect, a desiccant (possibly also for desuckering) and biocide method comprising the use of the formulations of the invention is described.

### BRIEF DESCRIPTION OF THE DRAWINGS

FIG. 1 shows a detail of the action of the herbicide on a monocotyledonous weed;

FIG. 2 shows a detail of the action of the herbicide on a dicotyledonous weed;

FIG. 3 shows a detail of the effect on weeds after 10 days of treatment with the desiccant of the invention in the summer;

FIG. 4 shows a portion of an orchard treated with a composition according to the invention;

FIGS. 5A and 5B show the effect on olive suckers;

FIG. 6 shows the effect on a green area treated (right) and untreated (left) with the compositions of the invention;

FIG. 7 shows the effects produced after the biocide treatment on a kiwi plant.

### DETAILED DESCRIPTION OF THE INVENTION

According to a first aspect, formulations with a desiccant and, if required, desuckering activity are provided.

In addition to the desiccant activity, formulations can have desuckering activity.

In a preferred aspect, the formulations of the invention may possibly also have a biocidal activity.

The term desiccant refers to the property of producing the desiccation of physical nature of weeds.

Such a desiccation is comparable to flame weeding.

“Desuckering” means the activity against suckers.

By biocidal activity it is meant that the formulations of the invention are active against:
fungi, in particular:
   Ascomycota (Erisiphaceae), Fusarium spp. (in particular on cucurbitaceae and solaneceae);
bacteria, in particular of the genus:
   Pseudomonas spp., Pseudomonas siringae PV Actinidia, Xanthomonas spp., Xanthomonas campestris, Erwinia carotovora, Clavibacterium michiganense, Agrobacterium tumafaciens, Agrobacterium spp., Erwinia spp., Corynebacterium spp; more in detail: Pseudomonas syringae PV Actinidia (in particular on kiwi), Xanthomonas campestris (in particular on the “TC SUN” CV plum), Erwinia carotovora (in particular on carrots), Clavibacterium michiganense (in particular on tomatoes in the greenhouse), Agrobacterium tumafaciens (in particular on nursery crops).

In a preferred aspect, the present invention describes desiccant and biocide formulations, which are not active against peronosporaceae.

According to the present invention, the described formulations comprise an organic acid, an oil and a tannic substance.

In a preferred aspect, the organic acid is selected from propionic acid and acetic acid.

In one particular aspect of the present invention, the acid is represented by propionic acid alone.

In an alternative aspect, the propionic acid can be partly replaced with acetic acid, thus obtaining a mixture of the two acids.

The substituted portion of propionic acid is preferably comprised up to a maximum of about 50%.

For the purposes of the present invention, the oil used may be a mineral or vegetable oil, or a mixture thereof.

In particular, a mineral oil is selected from the group comprising: white mineral oil, vaseline oil and other paraffinic oils, or mixtures thereof.

In particular, a vegetable oil is selected from the group comprising: karanja oil, jatropha oil, corn oil, sunflower oil, peanut oil, soybean oil, canola oil, etc., or mixtures thereof.

In a preferred aspect of the invention, soybean oil is used.

A tannic substance means a substance or a mixture of tannic substances.

In particular, a substance having a titer of at least 30%, preferably at least 70-75% tannin, can be used.

In a preferred aspect, this substance is represented by tannin, preferably extracted from chestnut wood.

In a preferred aspect of the invention, the described formulations further comprise an emulsifying agent.

In particular, this agent is selected from the group which comprises: soy lecithin (E322), saponins or saponosides (terpenic glycosides of vegetable origin), etc., or mixtures thereof.

In a preferred aspect, the emulsifier is represented by soy lecithin (E322).

According to the present invention, the formulations described have the following composition:

| Component | Amount (weight/weight) |
|---|---|
| Propionic acid | 70-80 |
| Vegetable oils | 10-20 |
| Emulsifying agent | 3-6 |
| Tannic substance | 5-10 |

According to an aspect of the invention, the formulations described have the following composition:

| Component | Amount (weight/weight) |
|---|---|
| Propionic acid | 40% |
| Acetic acid | 40% |
| Vegetable oil | 10-20% |
| Tannic substance | 5-10% |
| Emulsifier | 3-6% |

In one aspect of the invention, the formulations may comprise further components.

According to a second aspect, the present invention describes a process for preparing the formulations of the invention.

In particular, the process comprises the step of adding the tannic substance, the oil and the emulsifier to propionic acid, or to the mixture of propionic acid and its optional partial substitution, under stirring in a high-speed reactor.

Preferably, the speed is >1,500 rpm.

Stirring is maintained for at least an hour.

In a next step, the product is filtered.

Preferably, a filter with meshes of about 120-130 mesh is used.

Packaging must take place in the containers provided for by the regulations.

According to a third aspect, the present invention provides a desiccant method for use in the agricultural field, which comprises the use of the above formulations for the elimination of weeds.

In a preferred aspect, the invention provides a biocide (antifungal, antibacterial) method for use in the agricultural field, which comprises the use of the formulations described above.

In particular, for the treatment of Sclerotinia, Botrytis, Fusarium and Rhizoctonia infections, the formulations of the invention are applied at a dosage which provides for a preferred dilution of about 1 liter of formulation in 100 liters of water.

In an even more preferred aspect, the invention provides a biocide (antifungal, antibacterial) and desiccant method for use in the agricultural field, which comprises the use of the formulations described above.

The application of the formulations of the invention is preferably carried out by means of micronizers, either manual or mechanical, with very low volume, capable of dispersing 15-60 liters of formulation per hectare (1 hectare=10,000 m²).

This is possible due to the possibility of producing homogeneous microdroplets of about 200-300 microns and preferably of 250 microns.

In a preferred aspect of the invention, the formulations are applied pure, i.e. without dilution, for desiccant purposes.

In the presence of weeds in the first vegetative stages, the formulations can be diluted in a maximum ratio of 2:1, preferably of 3:1 (formulation:water) with water.

The formulations may be used for foliar applications and for root applications, by means of the localized irrigation system.

The application can take place in particular on agricultural crops (fruit growing, viticulture, olive growing, etc.), industrial crops, ornamental crops, nurseries, on lawns, also for organic crops.

According to another aspect, the present invention provides a desiccant method which comprises the use of the above formulations.

The lowest doses refer to the summer period, characterized by high temperatures and long exposure to the sun.

In particular, reference is made to dicotyledonous weed species (broad-leaved weeds).

In spring and autumn, in the presence of unfavorable thermal conditions and sun exposure, the necessary dosages are generally higher.

In particular, reference is made to monocotyledon weeds (i.e. narrow-leaved, grass-like).

For the purposes of the present invention, the desiccant method is preferably carried out in the absence of one or more of the following conditions:
advanced vegetative stage,
low temperatures (below 15° C.)
low sun exposure (about 5-6 hours).

In a still further aspect of the present invention, the formulations described can be employed in a biocide method to prevent the development of fungi during fruit preservation, which includes contacting the fruit with a formulation according to the present invention, e.g. by immersion.

In particular, the formulation used includes only propionic acid as organic acid, mixed with oligosaccharides (particularly inulin), polysaccharides and other sugars, which reduce the water part of the fruit, thus improving shelf-life.

In this regard, a bath can be prepared with the above biocide dilutions.

Typically, fruit develops fungi such as Penicillium, Botrytis, Monilinia, etc.

### Example 1

A liquid formulation according to the invention is prepared from:

| Component | Amount (weight/weight) |
|---|---|
| Propionic acid | 77 |
| Soybean oil | 10 |
| Soy lecithin | 3 |
| Tannin | 10 |

For the preparation of the formulation, propionic acid is poured in an airtight reactor equipped with a high-speed (>1500 rpm) propeller stirring system, preferably with a double column, equipped with an inverter (in order to allow processing in both directions), while the system is stirring and tannin, soybean oil and soy lecithin are added. The whole mass is left under stirring for about one hour. Once the stirring time is over, the product must be filtered at 120-130 mesh and packaged in the appropriate homologated packaging.

A similar procedure is performed from the following components:

| Component | Amount (weight/weight) |
|---|---|
| Propionic acid | 40% |
| Acetic acid | 40% |
| Vegetable oil | 8% |
| Tannin | 8% |
| Emulsifier | 4% |

### Example 2

### Results

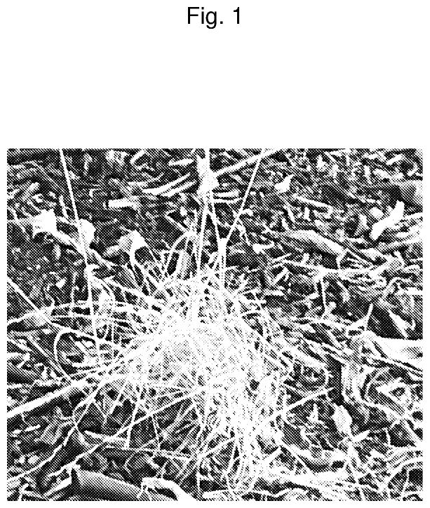

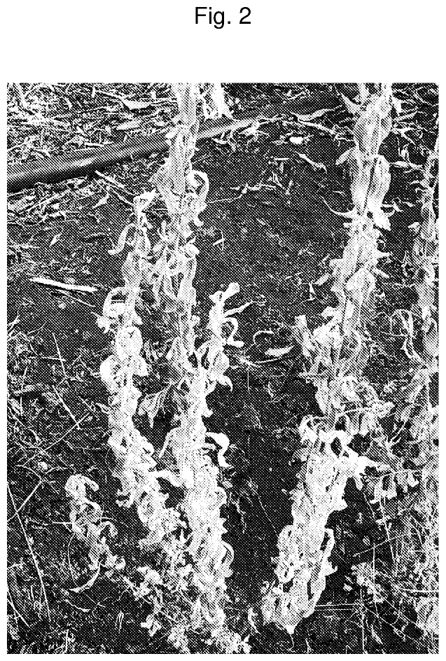

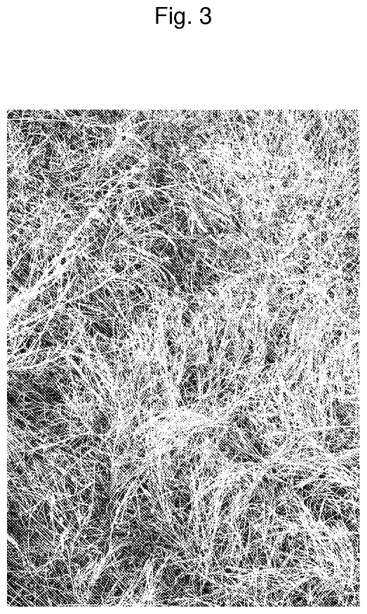

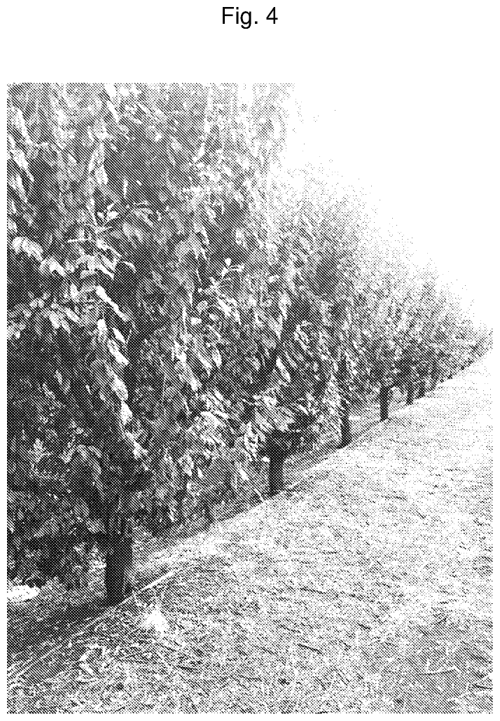

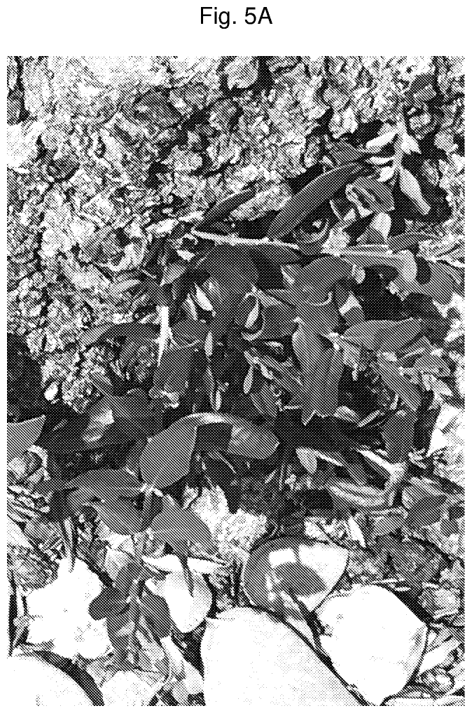

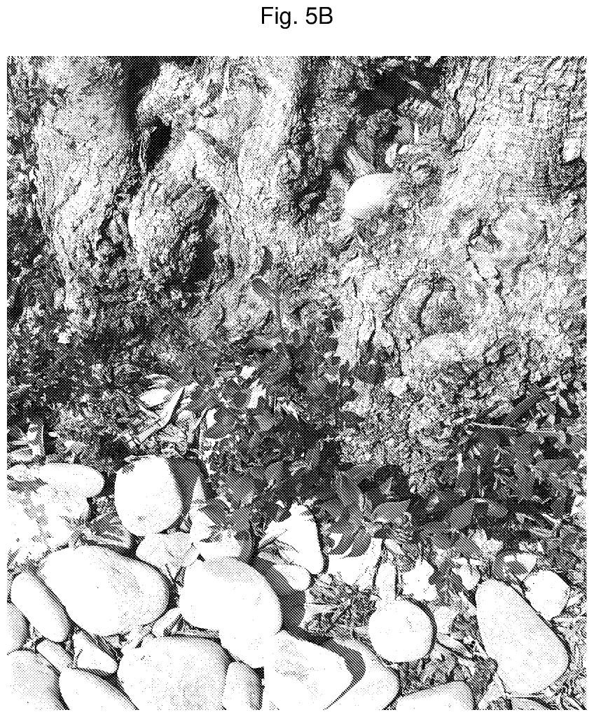

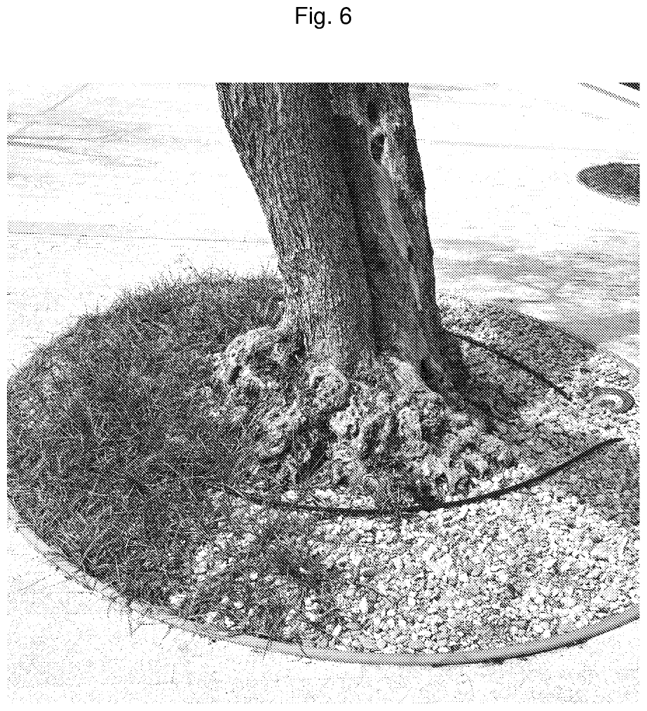

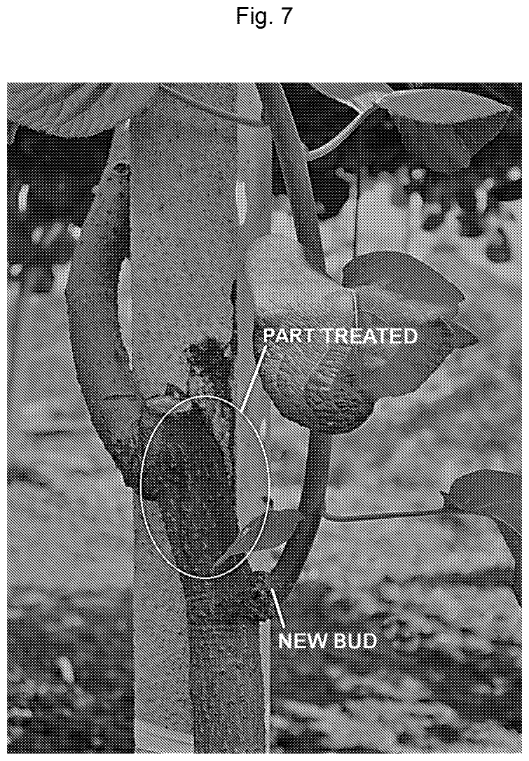

FIGS. 1, 2, 3, 4, 5 (A and B) and 6 show the results of the application of formulations according to the invention on monocotyledonous, dicotyledonous weeds, clearly highlighting the desiccating effects. In particular, the tests carried out have proved the following activities of the compositions of the invention:
contact desiccant, not systemic, with rhizogenic action on the adventitious roots of cultivated plants; in particular, for application on weeds in protected environments and in open fields for crops of: artichoke, tomato, strawberry, watermelon, melon, asparagus; leaf desiccant for potatoes (with selective action against tubers); under-canopy desiccant for the cultivation of the olive tree;
antifungal, especially for applications on crops of: hazel, vine, kiwi, olive, ornamental and nursery plants, fruit species; on kiwi plants affected by Pseudomonas siringae pv. Actididiae in particular, on-field tests have shown the possibility of obtaining the healing of the stem and the reclamation of new vegetation (FIG. 7);
desucker for crops of pomegranate, olive, hazelnut and other fruit crops grafted on particularly sucker rootstocks (MRS 2/5, quince, etc.).

From the description above those killed in the art will appreciate the several advantages offered by the present invention.

The formulations described in the present patent application have a dual activity:
biocide: if used at low concentrations, by means of the irrigation system located on the crop rows)
desiccant: when used at high concentrations (pure or diluted at a maximum ratio of 1:1 (formulation:water).

In particular, the biocidal activity is performed against both fungi and bacteria.

On the other hand, as regards the desiccant activity, this is advantageously both against monocotyledonous and dicotyledonous weeds.

Furthermore, the desiccant activity is of a physical nature and does not have any systemic effects on the plants.

The desiccant and weeding action (especially for potatoes) has a further advantage in the agricultural field, as it improves and facilitates the collection of the same agricultural products; for example, it favors the positioning of the olive harvesting nets.

Furthermore, the elimination of weeds favors and improves sun exposure, thus increasing the quality of agricultural products.

Last but not least, the formulations of the invention have shown to have a soil conditioning action, at a biochemical and physical level (corrective action on basic soils); in fact, they have proven to improve soil fertility.

Overall, the formulations of the invention can fall within the organic, environmentally sustainable, environmentally-friendly industry.

The possibility of using pure formulations or with a very low dilution, as described above, allows high efficiency of the same and an obvious and advantageous water saving, with clear positive environmental implications, allowing operating even in mountainous areas, where it is difficult to obtain water.

All the aforementioned activities are due to a synergistic effect between the components of the formulations of the invention.

The inventor of the present patent application, in fact, has surprisingly found that propionic acid (or a mixture thereof with an acid such as acetic acid) combined with an oil and a tannic substance forms a highly active composition, with unexpected effects both from the quantitative point of view (extent of the effect) and from the qualitative point of view (nature/type of effect) on the treated crops.

The specific formulation, moreover, has surprisingly proved to have a shelf life much higher than expected, with undoubted advantages from a practical, economic and commercial point of view.

Last but not least, it should be noted that the distribution of the products by means of very low-volume micronizers such as those described above can take place at 360°, 180° or even at 90°.

This allows operating in maximum safety for the crops in progress; in fact, it is thus possible to desiccate the infesting plants only on the rows of orchards, vineyards or citrus groves, without acting on the central rows.

In addition, the formulations can be used for crops in a protected environment, such as greenhouses, tunnels, nurseries, operating on the inter-rows, without acting on herbaceous and arboreal crops in cultivation.

Those skilled in the art can make adaptations and changes to the present invention described above and provide replacements of elements with others which are functionally equivalent, in order to meet specific incidental needs, without departing from the scope of the following claims.

1. A formulation with desiccant and biocide activity comprising an organic acid selected from propionic acid and acetic acid, an oil and a substance or a mixture of tannic substances.

2. A formulation according to the preceding claim, further comprising an emulsifying agent.

3. A formulation according to claim 1 or 2, comprising the following components:

| | Amount % |
|---|---|
| Component | (weight/weight) |
| Propionic acid | 70-80 |
| Vegetable oil | 10-20 |
| Emulsifying agent | 3-6 |
| Tannic substance | 5-10 |

4. A formulation according to claim 1 or 2, comprising the following components:

| | Amount % |
|---|---|
| Component | (weight/weight) |
| Propionic acid | 40 |
| Acetic acid | 40 |
| Vegetable oil | 10-20 |
| Emulsifying agent | 3-6 |
| Tannic substance | 5-10 |

5. Formulation according to any one of the preceding claims, wherein said oil is a vegetable oil selected from the group comprising: karanja oil, jatropha oil, corn oil, sunflower oil, peanut oil, soybean oil, canola oil or mixtures thereof; or a mineral oil selected from the group comprising: white mineral oil, vaseline oil and paraffinic oils or mixtures thereof; a mixture of both, and is preferably represented by soybean oil.

6. A formulation according to any one of the preceding claims, wherein said emulsifying agent is selected from the group comprising: soy lecithin, saponins or saponosides or mixtures thereof; and is preferably represented by soy lecithin.

7. A formulation according to any one of the preceding claims, wherein the tannic substance is represented by tannin, preferably extracted from chestnut wood.

8. A formulation according to any one of the preceding claims, wherein the tannic substance has a titer of at least 30%, preferably at least 70-75% tannin.

9. A formulation according to any one of the preceding claims, having the following composition:

| | Amount % |
|---|---|
| Component | (weight/weight) |
| Propionic acid | 70-80 |
| Soybean oil | 10-20 |
| Soy lecithin | 3-6 |
| Tannin | 5-10 |

10. A formulation according to any one of the preceding claims, having the following composition:

| | Amount % |
|---|---|
| Component | (weight/weight) |
| Propionic acid | 40% |
| Acetic acid | 40% |
| Vegetable oil | 8% |
| Tannin | 8% |
| Emulsifier | 4% |

11. A biocide method for the treatment of crops comprising the application on said crops of a formulation according to any one of the preceding claims.

12. Biocide method according to the preceding claim, wherein the crops are treated against:
fungi, in particular of the genus:
Ascomycota (Erisiphaceae), Fusarium spp. (in particular on cucurbitaceae and solaneceae);
bacteria, in particular of the genus:
Pseudomonas spp., Pseudomonas siringae PV Actinidia, Xanthomonas spp., Xanthomonas campestris, Erwinia carotovora, Clavibacterium michiganense, Agrobacterium tumafaciens, Agrobacterium spp., Erwinia spp., Corynebacterium spp.

13. A method according to the preceding claim 11 or 12, wherein said formulation is diluted in a 2:1 or 3:1 ratio with water (formulation:water).

14. A desiccant method for the treatment of crops for eliminating weeds which uses a formulation according to any one of claims 1 to 10.

15. The method according to the preceding claim, wherein said crops comprise monocot or dicot agricultural crops (fruit growing, viticulture, olive growing, etc.), industrial crops, ornamental crops, nurseries, on lawns, also for organic crops.

16. A method according to the preceding claim 14 or 15, wherein said formulation is used pure or diluted at most in a 1:1 ratio (formulation:water).

17. A desiccant and biocidal method comprising the use of a formulation according to any of claims 1 to 10.

18. A biocidal method to prevent the development of fungi during fruit preservation, which comprises contacting said fruit with a formulation according to any one of claims 1 to 10, wherein said organic acid is represented by propionic acid.
